(19) United States
(12) Patent Application Publication
(10) Pub. No.: US 2025/0222540 A1
(43) Pub. Date: Jul. 10, 2025

(54) Laser Machining Apparatus

(71) Applicant: SHIMADZU CORPORATION, Kyoto-shi (JP)

(72) Inventors: Naoya ISHIGAKI, Kyoto-shi (JP); Shingo UNO, Kyoto-shi (JP); Masaya SUWA, Kyoto shi (JP); Naoki WAKABAYASHI, Kyoto-shi (JP); Koji TOJO, Kyoto-shi (JP)

(21) Appl. No.: 18/846,931

(22) PCT Filed: Mar. 6, 2023
(86) PCT No.: PCT/JP2023/008284

§ 371 Date: Sep. 13, 2024

(30) Foreign Application Priority Data
Mar. 14, 2022 (JP) 2022-039028

(51) Int. Cl. B23K 26/06; B23K 26/082; B23K 26/21; B23K 26/38

(52) U.S. Cl. CPC B23K 26/0648; B23K 26/082; B23K 26/21; B23K 26/38

(57) ABSTRACT

Laser beams condensed by a condensing optical system are incident on an optical fiber (200). An irradiation mechanism (301) irradiates an object with light that comes out of the optical fiber (200). A movement mechanism (302) moves an irradiation region in the object irradiated with laser beams. The optical fiber (200) includes a core including an incidence plane on which laser beams condensed by the condensing optical system are incident. The incidence plane is in such a first elongated shape that a first direction is longer than a second direction, the first direction and the second direction being orthogonal to each other. The irradiation region is in a second elongated shape corresponding to the first elongated shape. The movement mechanism (302) moves the irradiation region in the first direction.

### TECHNICAL FIELD

The present disclosure relates to a laser machining apparatus.

### BACKGROUND ART

Japanese Patent Laying-Open No. 2017-152630 (PTL 1) proposes a laser beam output apparatus that outputs laser beams. This laser beam output apparatus includes a plurality of light sources arranged in an array, a condensing portion, and an optical fiber. The plurality of light sources each output a laser beam. The condensing portion condenses laser beams outputted from the plurality of light sources. Condensed laser beams are incident on the optical fiber.

### CITATION LIST

### Patent Literature

PTL 1: Japanese Patent Laying-Open No. 2017-152630

### SUMMARY OF INVENTION

### Technical Problem

The laser beam output apparatus described above can achieve higher output by arranging light sources in an array. In general, a laser machining apparatus has been desired to have increased density of power provided to an object to be machined.

The present disclosure was made to achieve such an object, and the object thereof is to provide a laser machining apparatus that achieves increase in density of power provided to an object to be machined.

### Solution to Problem

A laser machining apparatus in the present disclosure includes a plurality of light sources, a condensing optical system, an optical fiber, an irradiation mechanism, and a movement mechanism. The plurality of light sources output laser beams. The condensing optical system condenses laser beams outputted from the plurality of light sources. Laser beams condensed by the condensing optical system are incident on the optical fiber. The irradiation mechanism irradiates an object with light that comes out of the optical fiber. The movement mechanism moves an irradiation region in the object irradiated with laser beams. The optical fiber includes a core including an incidence plane on which laser beams condensed by the condensing optical system are incident. The incidence plane is in such a first elongated shape that a first direction is longer than a second direction, the first direction and the second direction being orthogonal to each other. The irradiation region is in a second elongated shape corresponding to the first elongated shape. The movement mechanism moves the irradiation region in the first direction.

### Advantageous Effects of Invention

The laser machining apparatus in the present disclosure can achieve increase in density of power provided to an object to be machined.

### BRIEF DESCRIPTION OF DRAWINGS

FIG. 1 is a diagram for illustrating an overall configuration of a laser machining apparatus in the present embodiment.

FIG. 2 is a diagram for illustrating a configuration of a light source unit.

FIG. 3 is a diagram for illustrating exemplary arrangement of a plurality of light sources.

FIG. 4 is a diagram for illustrating an exemplary first surface of an optical fiber.

FIG. 5 is a diagram for illustrating an irradiation region in an object irradiated with laser beams.

FIG. 6 is a diagram for illustrating a manner of irradiation by a laser machining apparatus in a first comparative example.

FIG. 7 is a diagram for illustrating a manner of irradiation by the laser machining apparatus in the present embodiment.

FIG. 8 is a diagram for illustrating a density or the like of power provided to a target region.

FIG. 9 is a diagram for illustrating comparison between the laser machining apparatus in the present embodiment and a laser machining apparatus in a second comparative example.

FIG. 10 is a diagram for illustrating energy density in an example where the irradiation region is in a circular shape.

FIG. 11 is a diagram for illustrating energy density in an example where the irradiation region is in a rectangular shape.

FIG. 12 is a diagram for illustrating a laser machining apparatus in a third comparative example.

FIG. 13 is a diagram for illustrating the laser machining apparatus in a second embodiment.

FIG. 14 is a diagram for illustrating an irradiation region in a third embodiment.

FIG. 15 is a diagram for illustrating an incidence plane of a core in the third embodiment.

FIG. 16 is a diagram for illustrating an exemplary configuration of a laser machining apparatus in a fourth embodiment.

### DESCRIPTION OF EMBODIMENTS

An embodiment of the present disclosure will be described in detail below with reference to the drawings. The same or corresponding elements in the drawings have the same reference characters allotted and description thereof will not be repeated.

### First Embodiment

### [Overall Configuration of Laser Machining Apparatus]

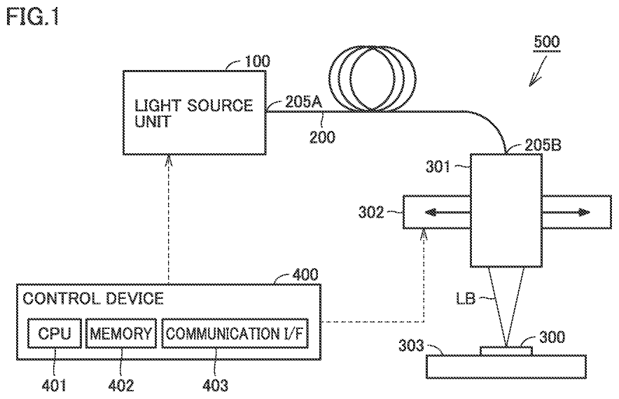

FIG. 1 is a diagram for illustrating an overall configuration of a laser machining apparatus 500. Laser machining apparatus 500 according to the present embodiment irradiates an object to be machined (which is also referred to as an “object 300” or a workpiece below) with laser beams to heat object 300. Laser machining apparatus 500 thus machines object 300 by melting or evaporating a material that forms object 300. In the present embodiment, machining includes welding and cutting. Machining may be a process for providing a recess in the object.

Laser machining apparatus 500 includes a light source unit 100, an optical fiber 200, an irradiation mechanism 301, a movement mechanism 302, a carrier 303, and a control device 400. Object 300 is arranged on carrier 303.

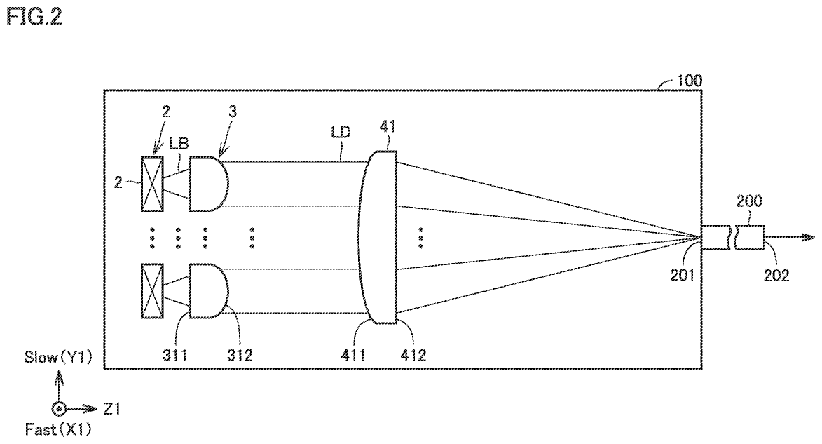

A configuration of light source unit 100 will be explained with reference to FIG. 2 which will be described later. Laser beams from light source unit 100 are incident on optical fiber 200 and propagate therethrough. FIG. 1 shows an incidence plane 205A and an emission plane 205B of optical fiber 200, which will be described later. Irradiation mechanism 301 includes a not-shown condenser. Irradiation mechanism 301 condenses through the condenser, laser beams that come out of optical fiber 200, and irradiates object 300 therewith. Movement mechanism 302 moves an irradiation region in object 300 irradiated with laser beams LB (laser beams LB emitted from irradiation mechanism 301). In the present embodiment, movement mechanism 302 moves the irradiation region by moving irradiation mechanism 301.

Control device 400 controls light source unit 100 and movement mechanism 302 based on an instruction or the like inputted by a user. Specifically, control device 400 controls light emission from a light source 2 (see FIG. 2) included in light source unit 100. Furthermore, control device 400 controls movement mechanism 302.

Control device 400 includes, as its main constituent elements, a central processing unit (CPU) 401, a memory 402, and a communication interface (I/F) 403. The constituent elements are connected to one another through a data bus. Memory 402 includes a read only memory (ROM), a random access memory (RAM), and the like.

A program to be executed by CPU 401 is stored in the ROM. Data or the like generated by execution of a program by CPU 401 is temporarily stored in the RAM. The RAM can function as a temporary data memory used as a work area.

Communication I/F 403 is an interface for output of a control signal to other devices under the control by CPU 401. Other devices are, for example, light source unit 100 and movement mechanism 302.

### [Configuration of Light Source Unit]

FIG. 2 is a diagram for illustrating the configuration of light source unit 100. As will be described later, laser beams emitted from the light source which will be described later have a Fast axis direction and a Slow axis direction. FIG. 2 is the diagram showing an arrangement configuration of each part of light source unit 100 in a plane including a Slow axis and a Z axis of laser beams.

In FIG. 2, the left side is also referred to as an “upstream side in a direction of an optical axis of light source unit 100” and the right side is also referred to as a “downstream side in the direction of the optical axis of light source unit 100.” The upstream side in the direction of the optical axis of light source unit 100 may simply be referred to as the “upstream side” and the downstream side in the direction of the optical axis of light source unit 100 may simply be referred to as the “downstream side.” Though various optical systems will be described below, the optical systems may each be composed of one lens or at least two lenses, or may include a constituent component other than the lens.

In FIG. 2, the Slow axis direction of laser beams (which are also referred to as “parallel light” below) collimated by a later-described collimating optical system 3 is a vertical axis direction. In FIG. 2, the Fast axis direction of collimated laser beams is a depth direction and the direction of the optical axis of collimated laser beams is a Z-axis direction. In FIG. 2, the Slow axis direction is also referred to as a Y1-axis direction, the Fast axis direction is also referred to as an X1-axis direction, and the Z-axis direction is also referred to as a Z1-axis direction.

As shown in FIG. 2, light source unit 100 includes S (S being an integer not smaller than 2) light sources 2, S collimating optical systems 3, and a condensing optical system 41. S light sources 2 are also referred to as a “light source group 2A.” S collimating optical systems 3 are also referred to as a “collimating optical system group 3A.”

S light sources 2 output S laser beams, respectively. S collimating optical systems 3 are arranged in correspondence, in optical paths of laser beams from S light sources 2, that is, on S laser optical axes, respectively. In other words, a single light source 2 and a single collimating optical system 3 are arranged on one-to-one basis.

Each collimating optical system 3 is arranged at such a position that the optical axis from light source 2 passes through the center thereof (the center of a collimating lens included in collimating optical system 3). The optical path between light source 2 and collimating optical system 3 is also referred to as an “optical path LD” below. In the example in FIG. 2, there are S optical paths LD.

Each collimating optical system 3 includes an incidence plane 311 on which laser beam LB is incident and an emission plane 312 from which laser beam LB goes out. Incidence plane 311 is formed as a plane. Emission plane 312 is formed as a convexly curved surface.

Collimating optical system 3 collimates laser beam LB from corresponding light source 2. Specifically, collimating optical system 3 collimates laser beam LB from corresponding light source 2 to parallel light in each of the Slow axis direction and the Fast axis direction. Collimating optical system 3 may be composed of a combination lens.

Condensing optical system 41 is arranged on the optical path of laser beam LB and on the downstream side of collimating optical system 3. Optical fiber 200 is arranged on the downstream side of condensing optical system 41.

Condensing optical system 41 is a lens that condenses laser beams LB toward optical fiber 200. Condensing optical system 41 includes an incidence plane 411 on which laser beams LB are incident and an emission plane 412 from which laser beams LB go out. Incidence plane 411 is formed as a convexly curved surface. Emission plane 412 is formed as a plane.

Optical fiber 200 is elongated. Optical fiber 200 is provided with a first surface 201 and a second surface 202. First surface 201 is an end face on the upstream side of optical fiber 200. Second surface 202 is an end face on the downstream side of optical fiber 200. A plurality of laser beams LB condensed by condensing optical system 41 are collectively incident on first surface 201. These laser beams LB are guided to second surface 202 through optical fiber 200 and emitted from second surface 202. Emitted laser beams LB are inputted to irradiation mechanism 301.

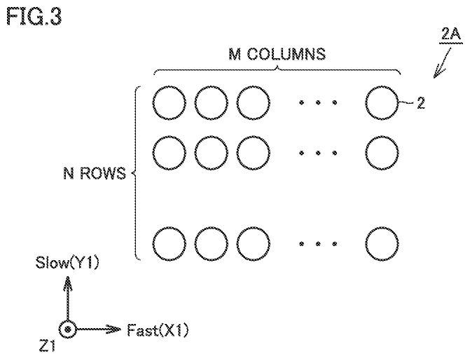

FIG. 3 is a diagram illustrating exemplary arrangement of S light sources 2. As shown in FIG. 3, S light sources 2 are two-dimensionally arranged in an array on an X1Y1 plane so as to be in a rectangular (quadrangular) shape. In the example in FIG. 3, light sources 2 in N rows and M columns are arranged. N is an integer not smaller than one, and more specifically an integer not smaller than two. M is an integer not smaller than one, and more specifically an integer not smaller than two. Sis calculated as S=M×N. The reason why S light sources 2 are thus arranged in the rectangular (quadrangular) shape will be described later.

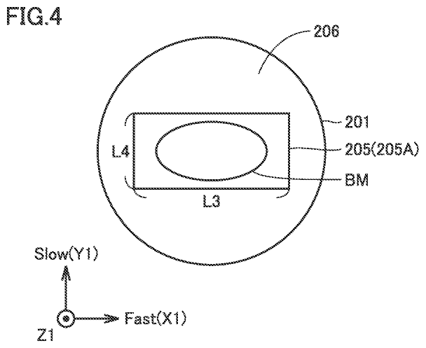

FIG. 4 is a diagram illustrating exemplary first surface 201 of optical fiber 200. Optical fiber 200 includes a core 205 and a clad 206. Core 205 is provided with incidence plane 205A. Laser beams condensed by condensing optical system 41 are incident on incidence plane 205A. Incidence plane 205A is in such a shape that the X1-axis direction is longer than the Y1-axis direction, the X1-axis direction and the Y1-axis direction being orthogonal to each other. In the present embodiment, the shape of incidence plane 205A is also referred to as a “first elongated shape.” In the example in FIG. 4, incidence plane 205A is in a rectangular shape (quadrangular shape). A long side of incidence plane 205A is defined as a long side L3 and a short side thereof is defined as a short side L4. Core 205 is in a shape of an elongated parallelepiped. In other words, the shape of the emission plane of core 205 is identical to the shape (rectangular shape) of incidence plane 205A.

As shown in FIG. 4, a beam diameter of laser beams condensed by condensing optical system 41 is in an oval shape. In the present embodiment, light source 2 is implemented by an edge-emitting laser diode. Since the beam diameter in the Fast axis direction is thus larger than the beam diameter in the Slow axis direction, the beam diameter is in the oval shape. Difference between the beam diameter in the Fast axis direction and the beam diameter in the Slow axis direction in the present disclosure is also expressed as “anisotropy.”

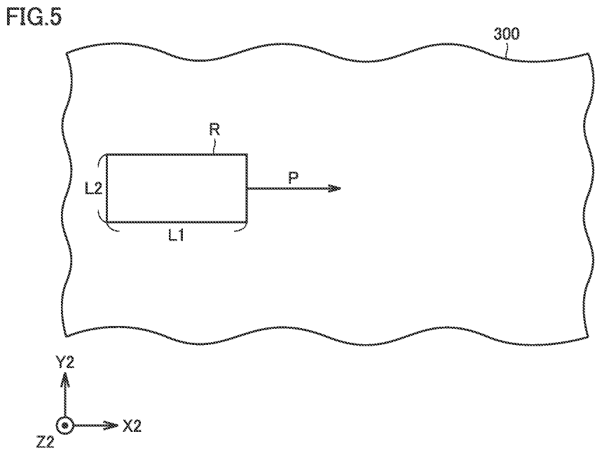

FIG. 5 is a diagram illustrating a region (which is alto referred to as an “irradiation region R” below) in object 300, of irradiation with laser beams LB from irradiation mechanism 301. The shape of irradiation region R is also referred to as a “second elongated shape” below. In the example in FIG. 5, a direction of irradiation with laser beams is defined as a Z2-axis direction. A direction orthogonal to the Z2-axis direction is defined as an X2-axis direction and a direction orthogonal to the Z2-axis direction and the X2-axis direction is defined as a “Y2-axis direction.” The X1-axis direction, the Y1-axis direction, and the Z1-axis direction in FIG. 4 may be the same as or different from the X2-axis direction, the Y2-axis direction, and the Z2-axis direction, respectively.

Irradiation region R is in such a shape that the X2-axis direction is longer than the Y2-axis direction. The X2-axis direction corresponds to the “first direction” in the present disclosure and the Y2-axis direction corresponds to the “second direction” in the present disclosure. In the example in FIG. 5, irradiation region R is in the rectangular shape (quadrangular shape). Irradiation region R has a longitudinal direction (the X2-axis direction or the first direction) and a short-side direction (the Y2-axis direction or the second direction). Irradiation region R is provided with a long side L1 and a short side L2. As shown with an arrow P, movement mechanism 302 moves irradiation region R in the X2-axis direction (the first direction or the longitudinal direction).

In the present embodiment, the second elongated shape (the shape of irradiation region R) corresponds to the first elongated shape (the shape of incidence plane 205A of core 205). In other words, the first elongated shape and the second elongated shape are identical in type of the shape. For example, when the first elongated shape is in the rectangular shape, the second elongated shape may also be in the rectangular shape. The first elongated shape may be identical to the second elongated shape in ratio between the long side and the short side. In this case, an expression (1) below is satisfied.

L1:L2=L3:L4 (1)

Array arrangement of light sources 2 is in the shape corresponding to the first elongated shape and rectangular. The array arrangement and the first elongated shape may substantially be identical to each other in ratio between the long side and the short side. In this case, an expression (2) below is satisfied.

L1:L2=length in accordance with M columns: length in accordance with N rows (2)

### [Density of Power of Laser Beams in Irradiation Region]

A technique to increase a power density of laser beams in irradiation region R will now be described. In general, in order to increase the power density, a laser output value (≅the number of coupled fibers (the number of light sources 2)) should be increased or an area of irradiation region R (≅an area of a fiber core) should be made smaller (see an expression (7) which will be described later). As will be described later, however, it is difficult to achieve both of increase in laser output value and reduction in area of irradiation region R.

In the present embodiment, in order to increase the area of the first elongated shape, the first elongated shape is set to be in the rectangular shape (quadrangular shape). Thus, while the laser output value is increased, the power density in the irradiation region can virtually be increased as will be described later.

“Output wattage (laser output value)” will initially be described. In order to increase output wattage, the number of beams (that is, the number of light sources 2) to be coupled at incidence plane 205A of optical fiber 200 should be increased. The maximum number C of beams to be coupled is expressed in an expression (3) below.

The maximum number C of coupled beams=D/E (3)

D in the expression (3) represents beam quality of beams that can be coupled to optical fiber 200. E in the expression (3) represents beam quality in the Fast axis direction of a laser beam from light source 2. Beam quality D is expressed in an expression (4) below.

D=(π·Lx·NA)/λ2 (4)

Lx in the expression (4) represents a length of a side (for example, a length of long side L3 in the example in FIG. 4) that coincides with the Fast axis direction of incidence plane 205A. NA represents an aperture of optical fiber 200. λ represents a wavelength of a laser beam from light source 2.

The expression (3) and the expression (4) are summarized to an expression (5) below.

C=(π·Lx·NA)/λ2·E (5)

For example, when conditions of NA=0.2, 2=450 nm, beam quality E in the Fast axis direction of laser beam=1.3, and Lx=100 μm are set, the maximum number C of coupled beams is fifty-three. When conditions of NA=0.2, 2=450 nm, beam quality E in the Fast axis direction of laser beam=1.3, and Lx=200 μm are set, the maximum number C of coupled beams is one hundred and seven.

When Lx is a variable and values other than Lx are constants on the right side of the expression (5), output wattage G from optical fiber 200 is expressed in an expression (6) below.

Output wattage G from optical fiber 200=a·Lx (6)
a in the expression (6) is a constant. In other words, output wattage G from optical fiber 200 is in proportion to side Lx as in the expression (6).

A power density F will now be described. Power density F is expressed in an expression (7) below.

Power density F=output wattage G/area of irradiation region R (7)

When laser machining apparatus 500 performs welding or cutting of object 300 with laser beams as described above, output from optical fiber 200 is condensed by condensing optical system 41 or the like and object 300 is irradiated therewith. The area of irradiation region R (light condensation spot) in object 300 is in proportion to the area of incidence plane 205A of core 205 of optical fiber 200.

Laser machining apparatus 500 is capable of finer machining, by irradiation region R being made smaller. By making irradiation region R smaller, the power density becomes higher and a penetration depth in welding and a cutting depth in cutting can increase. By moving the irradiation region at a lower speed, an amount of introduction of heat into object 300 per unit area can be made larger, whereas the speed of cutting or welding lowers. Laser machining apparatus 500, on the other hand, can improve a speed of cutting or welding by increase in amount of introduction of heat into object 300 per unit time or per unit area. Therefore, increase in area of incidence plane 205A of core 205 of optical fiber 200 with attention being paid only to higher output of optical fiber 200 is not necessarily practical in a machining application, and laser machining apparatus 500 that achieves both of higher output and power density F is preferred.

As shown in the expression (6), in order to increase output wattage G, Lx should be increased and the number of light sources should be increased. When Lx is increased in order to increase output wattage G, however, the area of incidence plane 205A becomes large and consequently the “area of irradiation region R” which is the denominator of the right side in the expression (7) becomes large.

In other words, the laser output value (output wattage G) and the area of irradiation region R are in a trade-off. Therefore, it is difficult to achieve both of increase in laser output value and decrease in area of irradiation region R as described above. Accordingly, it has conventionally been difficult to increase the power density of laser beams in irradiation region R.

Then, in the present embodiment, as shown in FIG. 5, irradiation region R is set to be in the second elongated shape described above. Laser machining apparatus 500 can thus achieve increase in power density of laser beams in irradiation region R in object 300, as will be described later.

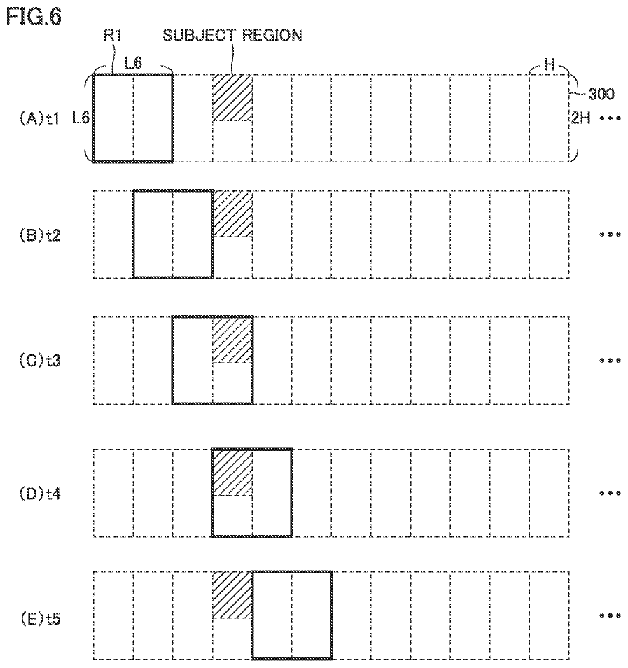

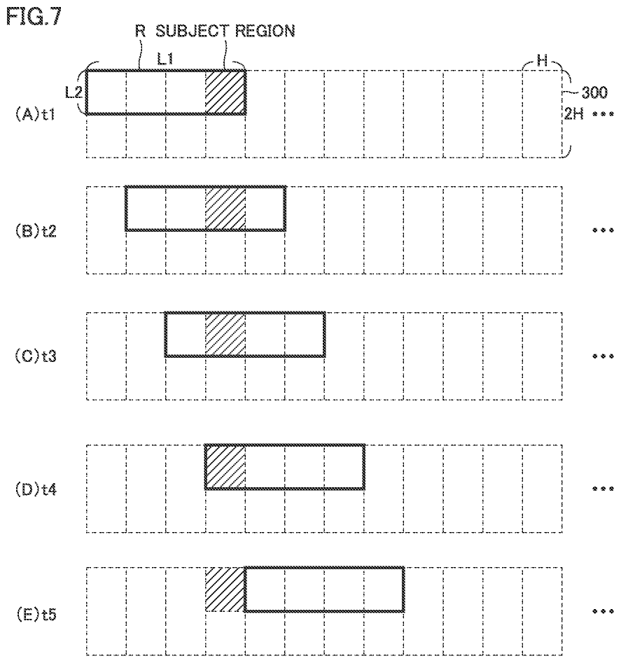

FIG. 6 is a diagram illustrating a manner of irradiation of object 300 by a laser machining apparatus in a first comparative example. FIG. 7 is a diagram illustrating a manner of irradiation of object 300 by laser machining apparatus 500 in the present embodiment. The irradiation region in FIGS. 6 and 7 is a region surrounded by a bold line. An irradiation region R1 irradiated by the laser machining apparatus in the first comparative example is square and irradiation region R irradiated by laser machining apparatus 500 in the present embodiment is rectangular as described above.

A moving distance per unit time, of irradiation region R and irradiation region R1 is set to a distance H. As shown in FIG. 6, one side of square irradiation region R1 has a length L6 twice as long as distance H. Length L6 is one-half of L1 and also twice as long as L2. As shown in FIG. 7, long side L1 of irradiation region R in the present embodiment is four times as long as distance H and short side L2 is as long as distance H.

FIGS. 6 and 7 show transition of the irradiation region every unit time. Time after lapse of each unit time is denoted as t1 to t5. FIG. 6(A) to (E) shows respective positions of irradiation region R1 at time t1 to time t5. FIG. 7(A) to (E) shows respective positions of irradiation region R at time t1 to time t5.

Distance H is set to 50 μm. Therefore, irradiation region R1 is a square region with a side length of 100 μm, and has an area of 100 μm×100 μm. Irradiation region R has long side L1 of 200 μm and short side L2 of 50 μm, and has an area of 50 μm×200 μm. Therefore, the area of irradiation region R1 is equal to the area of irradiation region R.

It is assumed that the laser machining apparatus in the first comparative example and laser machining apparatus 500 in the present embodiment are identical in number of light sources 2 and both have output wattage G from optical fiber 200 of 100W.

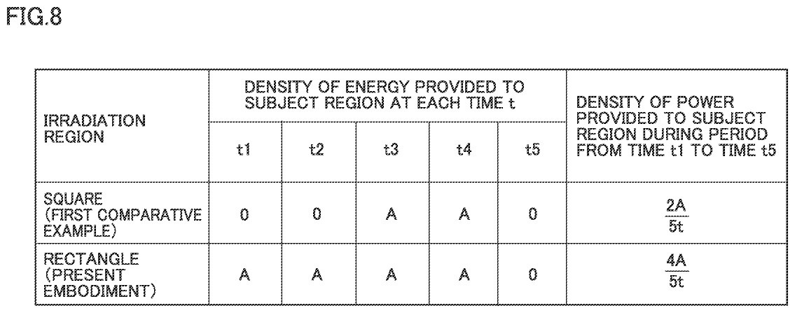

The density of power provided to the target region (hatched region) shown in FIGS. 6 and 7 will now be described. FIG. 8 is a diagram illustrating a density or the like of power provided to the target region. The example in FIG. 8 shows a “density of energy provided to target region at each time t (t1 to t5)” and a “density of power provided to target region during period from time t1 to time t5.” In the example in FIG. 8, the density of energy provided to the target region during one unit time period is assumed as “A”. Energy (J) provided to the target region is expressed in an expression (8) below.

Energy (J)=power (W)×time (s) (8)

In addition, an energy density is expressed in an expression (9) below.

Energy density=energy (J)/area (cm²) of target region (9)

In the example in FIG. 6, in the laser machining apparatus in the first comparative example where irradiation region R1 is square, at time t1, time t2, and time t5, the target region is not included in irradiation region R1. Therefore, as shown in FIG. 8, at each of time t1, time t2, and time t5, the density of energy provided to the target region is 0. In the example in FIG. 6, at time t3 and time t4, the target region is included in irradiation region R1. Therefore, at each of time t3 and time t4, the density of energy provided to the target region is A. Therefore, an integrated value of energy provided to the target region during the period from time t1 to time t5 is 2A·S. S represents a value of the area of irradiation region R.

In the example in FIG. 7, in the laser machining apparatus in the present embodiment where irradiation region R is rectangular, at time t1 to time t4, the target region is included in irradiation region R. Therefore, at each of time t1 to time t4, the density of energy provided to the target region is A. At time t5, the target region is not included in the irradiation region. Therefore, at time t5, the density of energy provided to the target region is 0. Therefore, the integrated value of energy provided to the target region during the period from time t1 to time t5 is 4A·S.

When an irradiation time period 5t is sufficiently short and influence by diffusion or the like of thermal energy in object 300 is ignorable, for example, a virtual power density is expressed in an expression (10) below.

Virtual power density (W/cm²)=integrated value of energy within irradiation time period(=5t)/(irradiation time period·area of irradiation region) (10)

Therefore, as shown in the field of “density of power from t1 to t5” in FIG. 8, the power density in the comparative example within the irradiation time period (5t) is 2A/5t (W/cm²) based on the expression (10). The power density in the present embodiment within the irradiation time period (5t) is 4A/5t (W/cm²). Therefore, the laser machining apparatus in the present embodiment can provide object 300 with the power density twice as high as that of the laser machining apparatus in the comparative example.

As set forth above, the integrated value of the energy density of laser beams in the irradiation region in object 300 irradiated by laser machining apparatus 500 in the present embodiment can be higher than the integrated value of the energy density of laser beams in the irradiation region in the object irradiated by the laser machining apparatus in the first comparative example as shown in FIG. 8. In other words, as shown in the field of “density of power from t1 to t5” in FIG. 8, laser machining apparatus 500 in the present embodiment can virtually achieve increase in power density in the irradiation region. Therefore, laser machining apparatus 500 can achieve increase in depth or thickness of laser beams into object 300. In the case of machining in which the same power density is required, laser machining apparatus 500 in the present embodiment can move the irradiation region at a higher speed than the laser machining apparatus in the first comparative example (the laser machining apparatus in which the irradiation region is in a positive direction).

A condition for obtaining an effect of this virtual increase in power density or magnitude of an amount of increase is different depending on a prescribed parameter of object 300. The parameter includes, for example, at least one of thermal conductivity of object 300, thermal diffusivity of object 300, a coefficient of absorption of light at a wavelength of light source 2 by object 300, and a method of holding object 300.

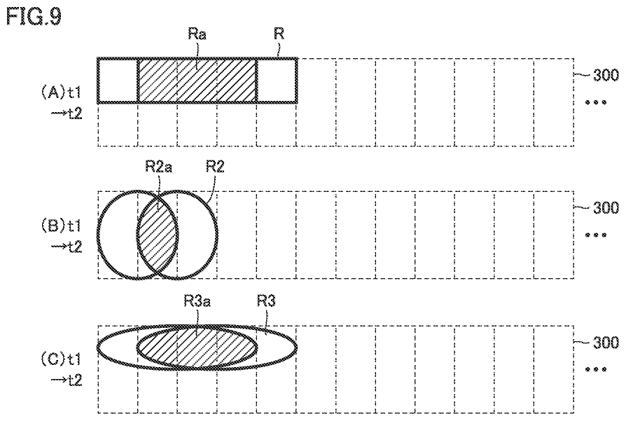

FIG. 9 is a diagram illustrating comparison between laser machining apparatus 500 in the present embodiment and a laser machining apparatus in a second comparative example. As shown in FIG. 9(A), the irradiation region irradiated by laser machining apparatus 500 in the present embodiment is rectangular. FIG. 9(A) is a diagram showing transition of irradiation region R from time t1 to time t2. FIG. 9 (A) shows an overlapping region Ra from time t1 until time t2. Overlapping region Ra is a region where irradiation region R at time t1 and irradiation region R at time t2 are superimposed on each other.

As shown in FIG. 9(B), the irradiation region irradiated by laser machining apparatus 500 in the second comparative example is circular. FIG. 9(B) is a diagram showing transition of an irradiation region R2 from time t1 until time t2. FIG. 9(B) shows an overlapping region R2a from time t1 until time t2.

As shown in FIG. 9(B), overlapping region R2a is a region surrounded by arcs. Therefore, overlapping region R2a is smaller in area than overlapping region Ra shown in FIG. 9(A). Therefore, the integrated value of the power density of laser beams in the irradiation region in object 300 irradiated by laser machining apparatus 500 in the present embodiment can be larger than the integrated value of the power density of laser beams in the irradiation region in the object irradiated by the laser machining apparatus in the second comparative example.

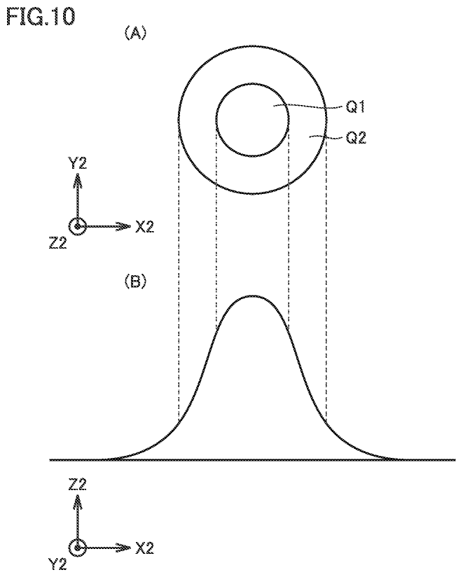

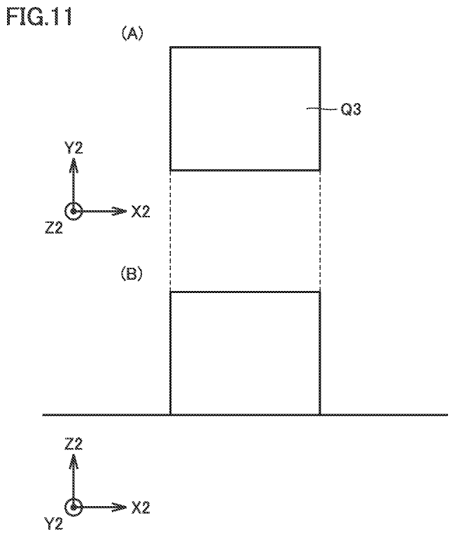

FIG. 10 is a diagram illustrating energy density in an example where the irradiation region is in a circular shape. FIG. 11 is a diagram illustrating energy density in an example where the irradiation region is in a rectangular shape. FIG. 10 (A) and 11(A) are diagrams showing the energy density on an X2Y2 plane and FIG. 10(B) and 10(B) are diagrams showing the energy density on an X2Z2 plane.

As shown in FIG. 10, when the irradiation region is in the circular shape, a distribution of the energy density in the irradiation region is in what is called a Gaussian shape. The Gaussian shape is such a shape that a central portion Q1 is higher in energy density than a peripheral portion Q2. As shown in FIG. 11, when the irradiation region is in the rectangular shape, the energy density is in a uniform shape in the irradiation region.

As shown in FIG. 10, when the irradiation region is in the circular shape, excessive energy is provided in the central portion of the irradiation region on object 300. Therefore, machining different from machining expected by the user or the like of laser machining apparatus 500 may be performed.

In laser machining apparatus 500 in the present embodiment, on the other hand, the irradiation region is in the rectangular shape. Therefore, the energy density is uniform in the irradiation region and laser machining apparatus 500 can perform machining expected by the user or the like.

Laser machining apparatus 500 in the present embodiment thus sets rectangular irradiation region R, and moves irradiation region R in the longitudinal direction of irradiation region R. Therefore, the area of the region that overlaps (which is also referred to as an “overlapping region” below) from time t1 to time t5 can be larger than in the first comparative example. Therefore, as shown in FIGS. 7 and 8, even when output wattage and the power density are both identical, the integrated value of the power density of laser beams in the irradiation region in object 300 irradiated by laser machining apparatus 500 in the present embodiment can be larger than the integrated value of the power density of laser beams in the irradiation region in the object irradiated by the laser machining apparatus in the first comparative example. Therefore, laser machining apparatus 500 in the present embodiment can achieve higher power density of laser beams in the irradiation region in the object than the laser machining apparatus in the first comparative example. In addition, similarly, laser machining apparatus 500 in the present embodiment can achieve higher power density of laser beams in the irradiation region in the object than the laser machining apparatus in the second comparative example.

Furthermore, irradiation region R in the present embodiment is in the rectangular shape. Therefore, as described with reference to FIG. 11, the energy density is uniform in the irradiation region and laser machining apparatus 500 can perform machining expected by the user or the like.

The shape of irradiation region R corresponds to the shape of incidence plane 205A of core 205. For example, when incidence plane 205A of core 205 has a circular shape, irradiation region R also has a circular shape. Alternatively, when incidence plane 205A of core 205 has a square shape, irradiation region R also has a square shape. Alternatively, when incidence plane 205A of core 205 has a rectangular shape, irradiation region R also has a rectangular shape.

In laser machining apparatus 500 in the present embodiment, incidence plane 205A of core 205 has a rectangular shape (see FIG. 4). Therefore, since laser machining apparatus 500 in the present embodiment can have irradiation region R in the rectangular shape without an adjustment optical system between emission plane 205B (see FIG. 1) of core 205 and object 300, the number of components does not have to be increased and loss of laser beams can be suppressed.

As shown in FIG. 3, S light sources 2 are two-dimensionally arranged in the elongated shape corresponding to the first elongated shape (incidence plane 205A). According to such a configuration, laser machining apparatus 500 can cause laser beams from S light sources 2 to be incident on incidence plane 205A in the first elongated shape without a special optical system.

As shown in FIGS. 1 and 5, laser machining apparatus 500 moves irradiation mechanism 301 to move irradiation region R in the direction shown with arrow P (that is, the X2-axis direction and the first direction). Therefore, since laser machining apparatus 500 can move irradiation region R in the longitudinal direction (the first direction), the integrated value of energy in overlapping region Ra in irradiation region R can be increased.

FIG. 5 shows an example in which the X2-axis direction and the direction shown with arrow P coincide with each other, that is, irradiation region R is moved along the X2-axis direction. When laser machining apparatus 500 changes a direction of movement of irradiation region R, it changes the direction of movement of irradiation region R so as to coincide with the longitudinal direction of irradiation region R. For example, when laser machining apparatus 500 changes the direction of movement of irradiation region R from the X2-axis direction to the Y2-axis direction, control device 400 controls movement mechanism 302 to drive irradiation mechanism 301 such that the longitudinal direction of irradiation region R coincides with the Y2-axis direction.

### Second Embodiment

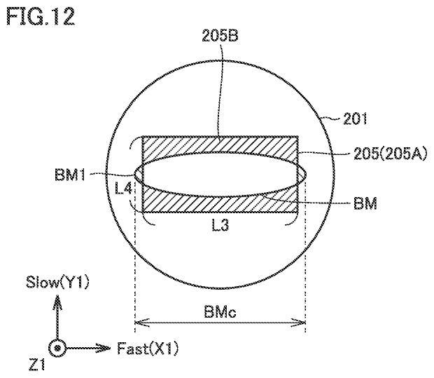

FIG. 12 is a diagram for illustrating a laser machining apparatus in a comparative example (which is also referred to as a “third comparative example” below) in a second embodiment. An example in FIG. 12 shows incidence plane 205A of core 205 in the third comparative example and laser beams BM incident on incidence plane 205A.

As shown in FIG. 12, a major axis BMc of oval laser beams BM may be longer than long side L3 of incidence plane 205A. In this case, all laser beams are not incident on the incidence plane (there is non-incident laser BM1). Therefore, an output value of optical fiber 200 becomes small. In addition, in the entire region of incidence plane 205A, there is a non-incidence region 205M on which laser beams are incident. In FIG. 12, non-incidence region 205M is hatched. Therefore, the area of incidence plane 205A is larger than necessary, and the power density of laser beams in object 300 lowers. The laser machining apparatus in the third comparative example may thus suffer from a problem of decrease in output value of optical fiber 200 or power density of laser beams.

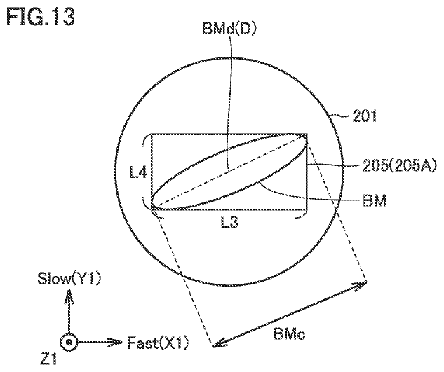

FIG. 13 is a diagram for illustrating laser machining apparatus 500 in the second embodiment. As shown in FIG. 13, a major axis BMd of laser beams BM on incidence plane 205A coincides with a diagonal D of incidence plane 205A. Specifically, the shape of condensing optical system 41 is set to such a shape that major axis BMd of laser beams BM coincides with diagonal D of incidence plane 205A. To “coincide” also encompasses “to substantially coincide.” “To substantially coincide” means that major axis BMd may slightly be displaced from diagonal D so long as an effect of increase in density of power provided by laser beams in the irradiation region irradiated with laser beams is achieved. According to such a configuration, even when major axis BMd of oval laser beams BM is longer than long side L3 of incidence plane 205A, laser beams can appropriately be incident on incidence plane 205A. Therefore, the problem that may be caused in the laser machining apparatus in the third comparative example can be suppressed.

### Third Embodiment

The configuration in which the irradiation region is in the rectangular shape is described with reference to FIG. 5 in the first or second embodiment. The irradiation region, however, may be in another shape.

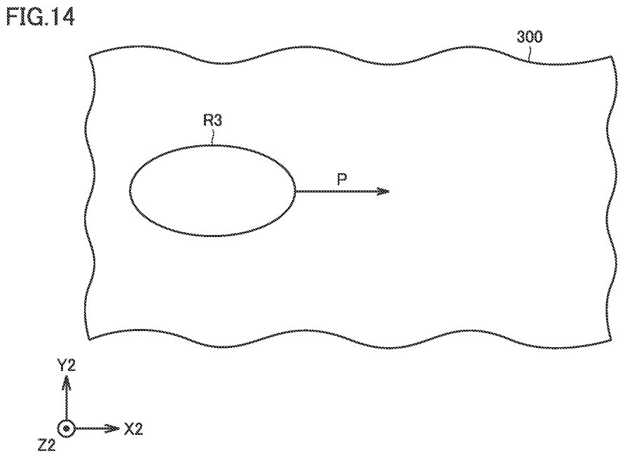

FIG. 14 is a diagram illustrating an irradiation region R3 in a third embodiment. In the example in FIG. 14, irradiation region R3 is in an oval shape. This oval shape is such a shape that the X2-axis direction is longer than the Y2-axis direction as in FIG. 5.

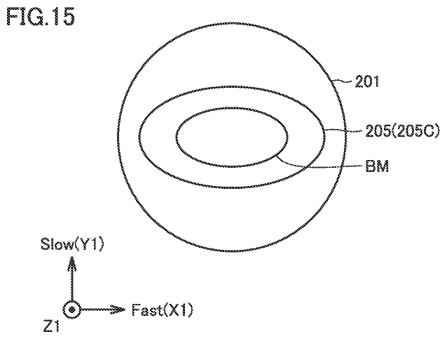

FIG. 15 is a diagram illustrating an incidence plane 205C of core 205 of optical fiber 200 in the third embodiment. In the example in FIG. 15, incidence plane 205C is in a shape corresponding to irradiation region R3. In the third embodiment, incidence plane 205C is in an oval shape.

FIG. 9 (C) is a diagram showing transition of irradiation region R3 from time t1 until time t2. FIG. 9 (C) shows an overlapping region R3a from time t1 until time t2.

As shown in FIG. 9 (C), in the laser machining apparatus in the third embodiment, overlapping region R3a can have an area larger than in the first comparative example (see FIG. 6). Therefore, even the laser machining apparatus in the third embodiment can achieve increase in integrated value of the power density of laser beams in irradiation region R3 in object 300. Therefore, the laser machining apparatus in the present embodiment can achieve higher power density of laser beams in the irradiation region in object 300 than the laser machining apparatus in the first comparative example.

Irradiation region R irradiated by the laser machining apparatus in the first embodiment is then compared with irradiation region R3 irradiated by the laser machining apparatus in the third embodiment. As described above, FIG. 9 (A) shows transition over time of irradiation region R irradiated by the laser machining apparatus in the first embodiment. FIG. 9 (C) shows transition over time of irradiation region R3 irradiated by the laser machining apparatus in the third embodiment.

As shown in FIG. 9 (C), overlapping region Ra3 is a region surrounded by curves of ovals. Therefore, overlapping region Ra3 is smaller in area than overlapping region Ra shown in FIG. 9 (A). The irradiation region is designed as appropriate to one of the rectangular shape and the oval shape depending on contents of machining of object 300.

The irradiation region may be in any shape without being limited to the rectangular shape and the oval shape so long as it is in such an elongated shape that the X2-axis direction (first direction) is longer than the Y2-axis direction (second direction). The irradiation region may be in any shape such as a parallelogram, a rhombus, or an ellipse.

### Fourth Embodiment

The configuration in which movement mechanism 302 moves irradiation mechanism 301 to move irradiation region R as shown in FIG. 1 is described in the first embodiment. The laser machining apparatus, however, may move irradiation region R with another method.

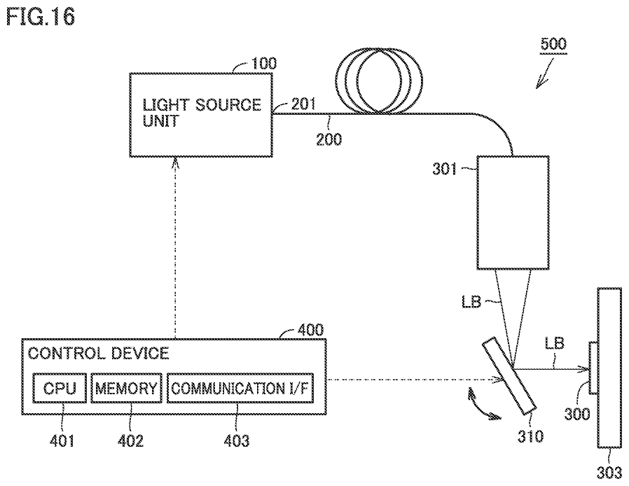

FIG. 16 is a diagram illustrating an exemplary configuration of a laser machining apparatus 500A in a fourth embodiment. As shown in FIG. 16, laser machining apparatus 500A does not include movement mechanism 302 but instead includes a galvano mirror 310. Laser beams LB emitted from irradiation mechanism 301 are reflected by galvano mirror 310 and object 300 is irradiated with reflected laser beams LB. Control device 400 can have galvano mirror 310 driven. Control device 400 has galvano mirror 310 rotationally driven such that irradiation region R is moved in the first direction (see FIG. 5). Even in such a fourth embodiment, irradiation region R can be moved in the first direction.

### Modification

The configuration in which movement mechanism 302 moves irradiation mechanism 301 to move the irradiation region is described in the embodiments above. Movement mechanism 302, however, may move carrier 303 rather than irradiation mechanism 301 such that irradiation region R is moved in the first direction. Such a configuration can also increase the power density of laser beams in the irradiation region in object 300. Alternatively, movement mechanism 302 may move both of irradiation mechanism 301 and carrier 303. In other words, movement mechanism 302 may move at least one of carrier 303 and irradiation mechanism 301 relative to each other such that the irradiation region is moved in the first direction. Such a configuration can also increase the power density of laser beams in the irradiation region in the object.

### Aspects

Illustrative embodiments described above are understood by a person skilled in the art as specific examples of aspects below.

(Clause 1) A laser machining apparatus according to one aspect or a laser machining apparatus in the present disclosure includes a plurality of light sources, a condensing optical system, an optical fiber, an irradiation mechanism, and a movement mechanism. The plurality of light sources output laser beams. The condensing optical system condenses laser beams outputted from the plurality of light sources. Laser beams condensed by the condensing optical system are incident on the optical fiber. The irradiation mechanism irradiates an object with light that comes out of the optical fiber. The movement mechanism moves an irradiation region in the object irradiated with laser beams. The optical fiber includes a core including an incidence plane on which laser beams condensed by the condensing optical system are incident. The incidence plane is in such a first elongated shape that a first direction is longer than a second direction, the first direction and the second direction being orthogonal to each other. The irradiation region is in a second elongated shape corresponding to the first elongated shape. The movement mechanism moves the irradiation region in the first direction.

According to such a configuration, the irradiation region in such a second elongated shape that the first direction is longer than the second direction is moved in the first direction, and this movement can make an overlapping region in the irradiation region larger. Therefore, a power density of laser beams in the overlapping region can be increased, and consequently the power density of laser beams in the irradiation region can be increased. Since the shape of the incidence plane is in such a first elongated shape that the first direction is longer than the second direction, the irradiation region can be in the second elongated shape without a special optical system.

(Clause 2) In the laser machining apparatus according to Clause 1, the first elongated shape is a first rectangle and the second elongated shape is a second rectangle.

According to such a configuration, the irradiation region can be in a rectangular shape without a special optical system.

(Clause 3) In the laser machining apparatus according to Clause 2, laser beams outputted from the plurality of light sources are anisotropic, and a major axis of laser beams on the incidence plane coincides with a diagonal of the first rectangle.

According to such a configuration, because of anisotropy of laser beams, a cross-section of beams may be in an oval shape. Even in such a case, laser beams condensed by the condensing optical system can be incident on the rectangular incidence plane.

(Clause 4) In the laser machining apparatus according to Clause 2, the first elongated shape is an oval and the second elongated shape is an oval.

According to such a configuration, the irradiation region can be in the oval shape without a special optical system.

(Clause 5) In the laser machining apparatus according to any one of Clauses 1 to 4, the plurality of light sources are two-dimensionally arranged in an elongated shape corresponding to the first elongated shape.

According to such a configuration, laser beams from a plurality of light sources can be incident on the incidence plane in the first elongated shape without a special optical system.

(Clause 6) In the laser machining apparatus according to any one of Clauses 1 to 5, the movement mechanism moves at least one of the object and the irradiation mechanism relative to each other such that the irradiation region is moved in the first direction.

According to such a configuration, the irradiation region can be moved along the first direction.

(Clause 7) In the laser machining apparatus according to any one of Clauses 1 to 6, the movement mechanism includes a mirror that can be driven to move the irradiation region in the first direction.

According to such a configuration, the irradiation region can be moved along the first direction.

It should be understood that the embodiments disclosed herein are illustrative and non-restrictive in every respect. The scope of the present disclosure is defined by the terms of the claims rather than the description of the embodiments above and is intended to include any modifications within the scope and meaning equivalent to the terms of the claims.

### REFERENCE SIGNS LIST

2 light source; 2A light source group; 3 collimating optical system; 3A collimating optical system group; 41 condensing optical system; 100 light source unit; 200 optical fiber; 201 first surface; 202 second surface; 205 core; 205A, 205B, 311, 411 incidence plane; 205M non-incidence region; 206 clad; 300 object; 301 irradiation mechanism; 302 movement mechanism; 303 carrier; 310 galvano mirror; 400 control device; 402 memory; 500, 500A laser machining apparatus

1. A laser machining apparatus comprising:
a plurality of light sources that output laser beams;
a condensing optical system that condenses laser beams outputted from the plurality of light sources;
an optical fiber on which laser beams condensed by the condensing optical system are incident;
an irradiation mechanism that irradiates an object with light that comes out of the optical fiber; and
a movement mechanism that moves an irradiation region in the object irradiated with laser beams, wherein
the optical fiber includes a core including an incidence plane on which laser beams condensed by the condensing optical system are incident,
the incidence plane is in such a first elongated shape that a first direction is longer than a second direction, the first direction and the second direction being orthogonal to each other,
the irradiation region is in a second elongated shape corresponding to the first elongated shape, and
the movement mechanism moves the irradiation region in the first direction.

2. The laser machining apparatus according to claim 1, wherein
the first elongated shape is a first rectangle, and
the second elongated shape is a second rectangle.

3. The laser machining apparatus according to claim 2, wherein
laser beams outputted from the plurality of light sources are anisotropic, and
a major axis of laser beams on the incidence plane coincides with a diagonal of the first rectangle.

4. The laser machining apparatus according to claim 1, wherein
the first elongated shape is an oval, and
the second elongated shape is an oval.

5. The laser machining apparatus according to claim 1, wherein
the plurality of light sources are two-dimensionally arranged in an elongated shape corresponding to the first elongated shape.

6. The laser machining apparatus according to claim 1, wherein
the movement mechanism moves at least one of the object and the irradiation mechanism relative to each other such that the irradiation region is moved in the first direction.

7. The laser machining apparatus according to claim 1, wherein
the movement mechanism includes a mirror that can be driven to move the irradiation region in the first direction.
